(19) United States
(12) Patent Application Publication
(10) Pub. No.: US 2013/0194676 A1
(43) Pub. Date: Aug. 1, 2013

(54) Glass Lens

(71) Applicants: Takashi Sannokyou, Hachioji-shi (JP); Hiroshi Nagoya, Fuchu-shi (JP)

(72) Inventors: Takashi Sannokyou, Hachioji-shi (JP); Hiroshi Nagoya, Fuchu-shi (JP)

(21) Appl. No.: 13/876,752

(22) PCT Filed: Sep. 8, 2011
(86) PCT No.: PCT/JP2011/070530

§ 371 Date: Mar. 28, 2013

(30) Foreign Application Priority Data
Sep. 30, 2010 (JP) 2010-223328

(51) Int. Cl. G02B 3/00

(52) U.S. Cl. CPC G02B 3/0037
USPC 359/642

(57) ABSTRACT

An object of the present invention is to provide a glass lens resistant to serious damage such as a crack during, for example, transport of a quadrangular glass lens such as a lens array formed by pressing molten glass or a compound lens obtained from the lens array. There are provided step portions 10a and 10c each having a reduced thickness on corners of a quadrangular contour, and hence, even when a corner portion is chipped or cracked during, for example, transport of a compound lens 10, it is possible to prevent the enlargement of the crack in the step portions 10a and 10c. Consequently, it is possible to suppress the occurrence of serious damage such as a crack which reaches the vicinity of optical surfaces 11d and 12d.

### TECHNICAL FIELD

The present invention relates to a glass lens obtained from a glass molded article molded by pressing molten glass, and particularly relates to an angular glass lens used as an image pickup lens or the like.

### BACKGROUND ART

As a glass lens, there is known a glass lens in which a flange portion provided around an optical function portion is formed with a recessed portion and an outer peripheral portion, and a protruded marking portion is provided in a part of the recessed portion inside the outer peripheral portion (see Patent Document 1).

As a plastic lens, there is known a plastic lens which is radially positioned by a step formed in a flange portion and a step formed in a frame for fixing the lens, and is fixed by filling a space between the surfaces of the steps which oppose each other with an adhesive (see Patent Document 2).

The glass lens of Patent Document 1 has a circular contour and is resistant to chips during transport. However, in the case of an angular glass lens having a quadrangular contour, its corner portion tends to be chipped during the transport thereof.

That is, in recent years, the image pickup lens incorporated in a cellular phone or the like is required to be reduced in size while its performance is maintained, and is mass-produced by processing a lens array in which a large number of lens elements are two-dimensionally disposed. Specifically, a large number of compound lenses are obtained by preparing plastic lens arrays or wafer-lens-type lens arrays which use glass substrates, stacking a plurality of the lens arrays on each other and adhering them to each other, and then cutting the stack into rectangular blocks.

On the other hand, it is also possible to form the lens array by pressing molten glass and, by performing the same processing as that performed on the above plastic or wafer-lens-type lens array on the lens array made of pure glass, it is possible to obtain a glass compound lens. However, when the glass lens array or the stack thereof is cut into the rectangular block, the corner portion of the rectangular block tends to be chipped during transport or the processing after the transport due to the fragility of the glass and a crack tends to be enlarged. When such damage is enlarged, there is a possibility that the durability of the glass lens is degraded and its optical performance is affected.

### CITATION LIST

### Patent Literature

Patent Document 1: Japanese Patent Application Laid-open No. 2004-188972

Patent Document 2: Japanese Patent Application Laid-open No. 2008-287757

### SUMMARY OF INVENTION

An object of the present invention is to provide a glass lens resistant to serious damage such as a crack or the like during transport of a quadrangular glass lens such as a lens array formed by pressing molten glass, or a lens element or a compound lens obtained from the lens array.

In order to solve the above problem, a glass lens according to the present invention includes a lens main body, and a flange portion or a brim-shaped portion extending around the lens main body, and the glass lens has a quadrangular contour when viewed from an optical axis direction of the lens main body, and a step portion having a reduced thickness on a corner of the quadrangular contour.

According to the above glass lens, since the glass lens has the step portion having the reduced thickness on the corner of the quadrangular contour, even when its corner portion is chipped or cracked during transport or the like, it is possible to prevent the enlargement of the crack in the step portion, and it is possible to suppress the occurrence of serious damage such as a crack which reaches the vicinity of an optical surface.

In a specific implementation or aspect of the present invention, in the above glass lens, the flange portion has the step portions on four corners of a quadrangular outline. In this case, in a case where a lens element having the set of the lens main body and the flange portion is handled when the lens element is cut out, it is possible to prevent formation of a large crack in the flange portion.

In another aspect of the present invention, the flange portion has the step portions on a front side and a back side respectively when viewed from the optical axis direction on the four corners of the quadrangular outline. In this case, in a case where the lens element is singly handled, it is possible to prevent the occurrence of serious damage to a corner portion protruding outwardly.

In still another aspect of the present invention, the above glass lens further includes a protruding mark on a surface of the step portion provided on at least one of the four corners of the quadrangular outline. In this case, it becomes possible to perform such as quality control, production management, and history management of the lens element or a lens array.

In yet another aspect of the present invention, the above glass lens is formed by stacking a plurality of lens elements each having a set of the lens main body and the flange portion on each other, and has the step portions in eight top portions of an outline having a shape of a quadrangular prism as a whole as a result of the stacking. In this case, in a case where the glass lens is handled as the compound lens obtained by the stacking, it is possible to prevent the occurrence of serious damage to the corner portion protruding outwardly.

In still another aspect of the present invention, the plurality of lens elements are stacked on each other in a state in which the flange portions are in contact with each other, and are bonded to each other by filling a space between opposing flange surfaces or the opposing step portions with an adhesive. In this case, alignment using the flange portion is allowed, and reliable adhesion between the plurality of lens elements is achieved by using the step portion.

In yet another aspect of the present invention, the above glass lens further includes a diaphragm which is sandwiched between the plurality of lens elements and fixed. In this case, it is possible to prevent the occurrence of stray light in the glass lens itself more reliably.

In still another aspect of the present invention, the above glass lens has a lens array in which a plurality of lens elements each having a set of the lens main body and the flange portion are two-dimensionally disposed and integrated, and the step portions on four corners of a quadrangular plate-like outline of the lens array. In this case, in a case where the lens array is singly handled, it is possible to prevent the occurrence of serious damage to the corner portion protruding outwardly.

In yet another aspect of the present invention, the above glass lens is formed by stacking a plurality of the lens arrays on each other, and has the step portions in eight top portions of an outline having a shape of a quadrangular prism as a whole as a result of the stacking. In a case where a stack of the lens arrays is handled, it is possible to prevent the occurrence of serious damage to the corner portion protruding outwardly.

### BRIEF DESCRIPTION OF DRAWINGS

FIG. 1(A) is a perspective view of a compound lens as a glass lens of a first embodiment, and FIG. 1(B) is a cross-sectional view of the compound lens;

FIG. 2(A) is a plan view of a lens array stack, FIG. 2(B) is a cross-sectional view of the lens array stack shown in FIG. 2(A) as viewed along arrows A-A, and FIG. 2(C) is a perspective view of the lens array stack shown in FIG. 2(A);

FIG. 3 is an exploded perspective view of the lens array stack shown in FIG. 2(A) and others;

FIG. 4 is a view for explaining a molding apparatus used in the production of a lens array serving as a material for the compound lens;

FIG. 5 is a view for explaining the molding apparatus used in the production of the lens array;

FIG. 6 is a perspective view for explaining a glass lens of a second embodiment and a production method therefor;

FIG. 7 is a perspective view for explaining a glass lens of a third embodiment and a production method therefor;

FIG. 8 is a cross-sectional view for explaining a glass lens of a fourth embodiment; and

FIG. 9 is a cross-sectional view for explaining a glass lens of a fifth embodiment.

### DESCRIPTION OF EMBODIMENTS

### First Embodiment

A description will be given of a glass lens (compound lens) according to a first embodiment of the present invention with reference to the drawings.

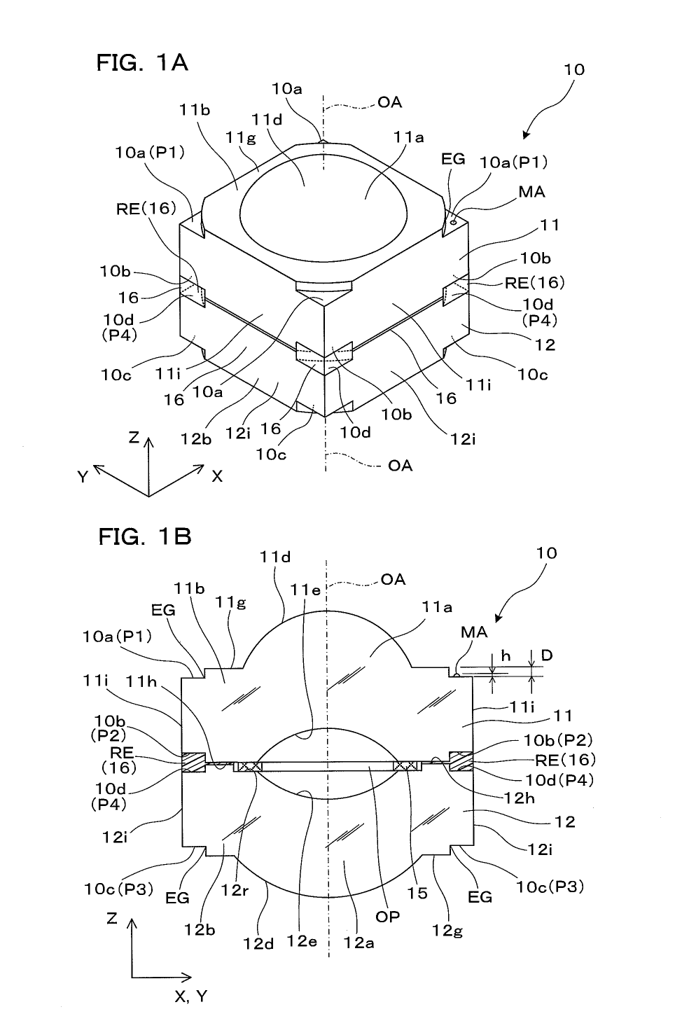

A compound lens 10 as a glass lens shown in FIGS. 1(A) and 1(B) is a member in the shape of a quadrangular prism cut out from a lens array stack described later by dicing (cutting), and has a quadrangular contour when viewed form the direction of an optical axis OA. The compound lens 10 includes a first lens element 11, a second lens element 12, and a diaphragm 15 sandwiched therebetween. Note that the compound lens 10 is accommodated in, e.g., an additionally prepared holder and is fixed to an image pickup element or device as an image pickup lens.

In the compound lens 10, the first lens element 11 is a glass lens having a lens main body 11a which has a circular contour and is provided in the central portion around the optical axis OA and a flange portion 11b which has a square contour and extends around the lens main body 11a. The lens main body 11a in the center is, e.g., a non-spherical lens portion, and has a pair of optical surfaces 11d and 11e. The surrounding brim-shaped flange portion 11b has a flat flange surface 11g extending around the front optical surface 11d and a flat flange surface 11h extending around the back optical surface 11e. The flange surfaces 11g and 11h are disposed in parallel with an XY plane vertical to the optical axis OA. In addition, the flange portion 11b has four side surfaces 11i which are disposed in the shape of a quadrangular tube or prism so as to be parallel with an XZ plane or a YZ plane between the flange surfaces 11g and 11h, and has a quadrangular outline as a whole. On the four corners of the quadrangular outline, the flange portion 11b has four step portions 10a on the front side when viewed from the direction of the optical axis OA, and has four step portions 10b on the back side when viewed from the direction of the optical axis OA. Among these, the four step portions 10a provided on the front side are formed adjacent to the outside of the front flange surface 11g, and have substantially triangular flat surfaces P1 as thin portions which are recessed from the flange surface 11g. On the other hand, the four step portions 10b provided on the back side are formed so as to be adjacent to the outside of the back flange surface 11h and oppose the step portions 10a on the front side, and have substantially triangular flat surfaces P2 as thin portions which are recessed from the flange surface 11h. Note that one step portion 10a of the four step portions 10a on the front side is formed with a mark MA as a sign comprised of one or more dome-shaped protrusions. A height h of the mark MA is set to be smaller or lower than a step D formed in the step portion 10a, and the top portion of the mark MA is thereby prevented from being higher than the flange surface 11g. The mark MA allows identification of the position of the lens array from which, e.g., the first lens element 11 is cut out. In a specific implementation, the step D of the step portion 10a was set to about 10 μm, and the height h of the mark MA was set to about 5 μm.

The second lens element 12 is also a glass lens having a lens main body 12a which has a circular contour and is provided in the central portion around the optical axis OA and a flange portion 12b which has a square contour and extends around the lens main body 12a. The lens main body 12a in the center is, e.g., a non-spherical lens portion, and has a pair of optical surfaces 12d and 12e. The surrounding flange portion 12b has a flat flange surface 12g extending around the front optical surface 12d and a flat flange surface 12h extending around the back optical surface 12e. The flange surfaces 12g and 12h are disposed in parallel with the XY plane vertical to the optical axis OA. In addition, the flange portion 12b has four side surfaces 12i which are disposed in the shape of the quadrangular tube or prism so as to be parallel with the XZ plane or the YZ plane between the flange surfaces 12g and 12h, and has the quadrangular outline as a whole. On the four corners of the quadrangular outline, the flange portion 12b has four step portions 10c on the front side when viewed from the direction of the optical axis OA, and has four step portions 10d on the back side when viewed from the direction of the optical axis OA. Among these, the four step portions 10c provided on the front side are formed adjacent to the outside of the front flange surface 12g, and have substantially triangular flat surfaces P3 as thin portions which are recessed from the flange surface 12g. On the other hand, the four step portions 10d provided on the back side are formed so as to be adjacent to the outside of the back flange surface 12h and oppose the step portions 10c on the front side, and have substantially triangular flat surfaces P4 as thin portions which are recessed from the flange surface 12h.

The diaphragm 15 is a ring-shaped member having an opening OP in the center, and is sandwiched between the inner peripheral side of the flange portion 11b of the first lens element 11 and the inner peripheral side of the flange portion 12b of the second lens element 12 to be fixed. In the example shown in the drawing, the diaphragm 15 is fitted in an annular groove 12r formed in the back side of the flange portion 12b of the second lens element 12. The diaphragm 15 is formed of, e.g. , a light-blocking metal plate or resin film, and prevents the occurrence of stray light in the compound lens 10 as the glass lens.

The outer peripheral side of the flange portion 11b of the first lens element 11 and the outer peripheral side of the flange portion 12b of the second lens element 12 are bonded and fixed to each other using an adhesive at an outer edge or separated four locations, and the compound lens 10 including the lens elements 11 and 12 can be handled as a single lens. Specifically, they are bonded to each other in a state where they are in intimate contact with each other by thinly applying an adhesive 16 as, e.g., a UV hardening resin to the portion between the flange surface 11h on the back side of the first lens element 11 and the flange surface 12h on the back side of the second lens element 12, and positioning (i.e., alignment) of the first lens element 11 and the second lens element 12 in the direction of the optical axis OA is thereby allowed. Further, the first lens element 11 and the second lens element 12 are disposed such that the step portions 10b and 10d provided on the back sides thereof precisely oppose each other with the relative rotation thereof about the optical axis OA. The step portions 10b and 10d oppose each other in a state where they are spaced from each other, and layer-like recesses RE are thereby formed. The portion of the adhesive 16 that has been applied to the flange surface 11h and the flange surface 12h and has become redundant as the result of the adhesion between the flange surface 11h and the flange surface 12h flows into the recesses RE, and the recesses RE are filled with the redundant portion of the adhesive 16. That is, each of the recesses RE has a role of receiving the redundant adhesive 16 on each of the four corners of the quadrangle of the flange portion 11b of the first lens element 11 and the flange portion 12b of the second lens element 12, and a further improvement in adhesion strength can be achieved by filling the recesses RE with the adhesive 16. In the above bonding, since the flange surface 11h of the first lens element 11 and the flange surface 12h of the second lens element 12 are adhered to each other via an extremely thin layer of the adhesive 16, the adjustment of the spacing between the lens elements 11 and 12 becomes accurate. In addition, the adhesion between the flange surfaces 11h and 12h prevents the occurrence of tilt. Further, by applying the appropriate amount of the adhesive 16 to the flange surfaces 11h and 12h in the vicinity of the recesses RE, the adhesive 16 before hardening is thinly spread between the flange surfaces 11h and 12h and the redundant portion of the adhesive 16 flows into the recesses RE, and hence it is possible to prevent the adhesive 16 before hardening from flowing to the optical surfaces 11e and 12e to the utmost extent.

In the foregoing, the compound lens 10 has the outline in the shape of a quadrangular prism as a whole as a result of the stacking, and has the step portions 10a and 10c in its eight top portions. Therefore, even if the step portions 10a and 10c are cracked when the compound lens 10 is transported or attached to an apparatus, the enlargement of the crack is prevented by edges EG of the step portions 10a and 10c, and hence serious damage extending from the corner portions protruding outwardly toward the optical surfaces 11d and 12d or the like is unlikely to occur.

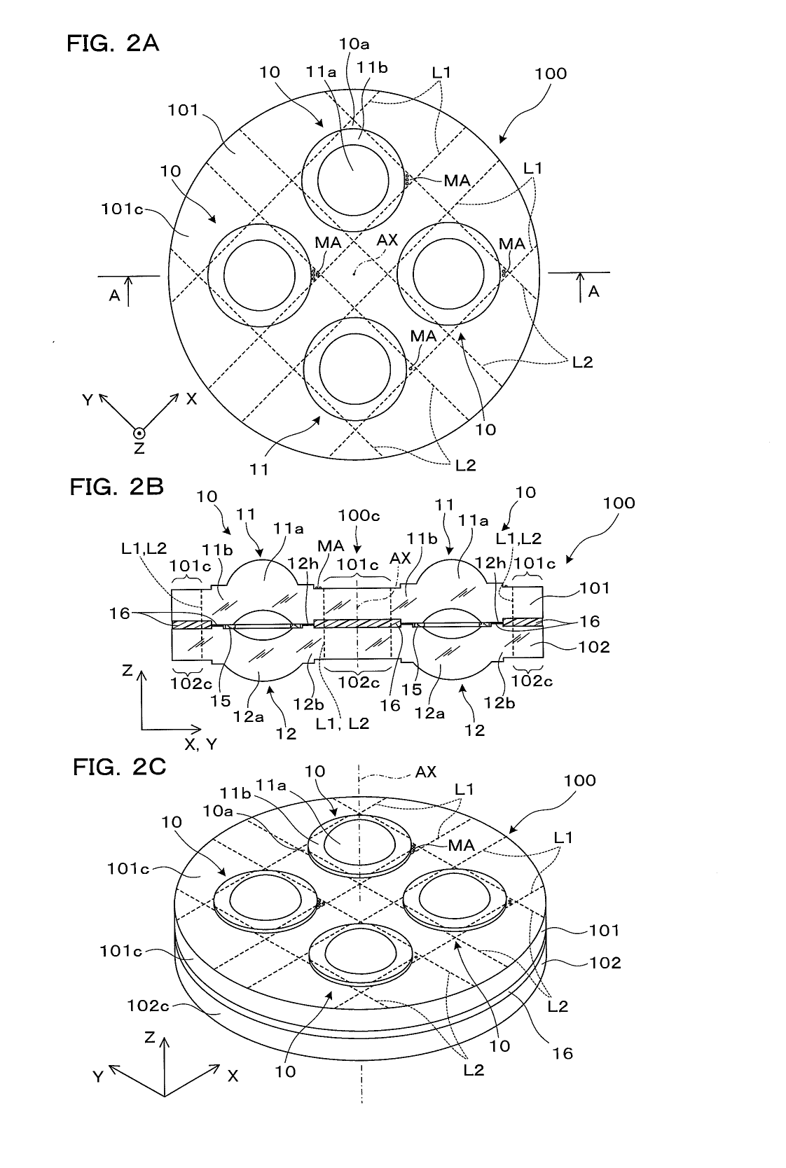

Hereinbelow, a description will be given of a production method for the compound lens 10 shown in FIG. 1(A) and others. First, a disc-like or cylindrical lens array stack 100 shown in FIGS. 2(A) to 2(c) is fabricated, and a coupling portion 100c of the lens array stack 100 is removed by using dicing (cutting) or the like to obtain, as the result of the division, the compound lenses 10 shown in FIG. 1(A) and others as four identical glass lenses in the shape of the quadrangular prism. In other words, in the lens array stack 100, a plurality of the compound lenses 10 are two-dimensionally disposed and integrated. Note that, in the lens array stack 100, the mark MA indicative of the position before cutting out is formed in advance in the corner of the region on the front surface side of each of the compound lenses 10.

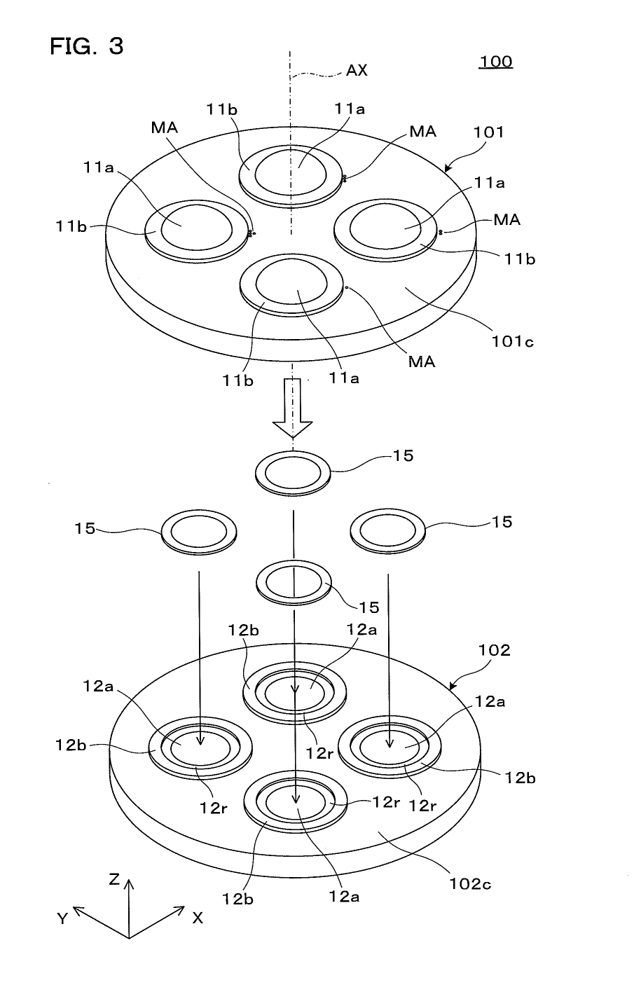

The lens array stack 100 is formed by aligning first and second lens arrays 101 and 102 shown in an exploded perspective view of FIG. 3 in terms of translation in an XY plane vertical to an axis AX and rotation about the axis AX and bonding the first and second lens arrays 101 and 102 to each other, and four diaphragms 15 are inserted between the first and second lens arrays 101 and 102 in correspondence to four compound lenses 10. The first lens array 101 is a semi-finished product in which four lens elements 11 each having the set of the lens main body 11a and the flange portion 11b are two-dimensionally disposed in the XY plane, and the four lens elements 11 are integrally formed via a coupling portion 101c. Similarly, the second lens array 102 is a semi-finished product in which four lens elements 12 each having the set of the lens main body 12a and the flange portion 12b are two-dimensionally disposed in the XY plane, and the four lens elements 12 are integrally formed via a coupling portion 102c.

When the first and second lens arrays 101 and 102 are bonded to each other, the diaphragms 15 are fitted in advance in four annular grooves 12r formed around the four second lens elements 12 provided in the second lens array 102. Thereafter, the adhesive 16 is thinly applied to the position of the flange surface 12h of the second lens array 102 that is close to the coupling portion 102c, the first lens array 101 is lowered toward the second lens array 102 and they are connected together, and the adhesive 16 between the flange surfaces 11h and 12h is hardened. At this point, the flange surface 11h of the first lens element 11 and the flange surface 12h of the second lens element 12 are bonded to each other in a state where they are in intimate contact with each other, and hence the unnecessary adhesive 16 does not remain between the flange surfaces 11h and 12h, and the redundant adhesive flows into the coupling portions 101c and 102c. Although the coupling portions 101c and 102c which oppose each other with the adhesive 16 interposed therebetween are mostly removed as the coupling portion 100c when the lens array stack 100 is divided by dicing or the like, four portions around the first lens element 11 and the second lens element 12 remain and serve as the step portions 10a, 10b, 10c, and 10d. That is, the step portions 10a, 10b, 10c, and 10d are corner portions that remain as the result of straight cutting, and are formed incidentally or automatically.

Note that, in the lens array stack 100 shown in FIG. 2(A) and others, boundary lines L1 extending in an X direction and boundary lines L2 extending in a Y direction indicate the outer edges of the four compound lenses 10 disposed at lattice points, and portions outside the compound lens 10 beyond the boundary lines L1 and L2 serve as the coupling portion 100c or the coupling portions 101c and 102c. The boundary lines L1 and L2 are used as references when dicing is performed on the lens array stack 100.

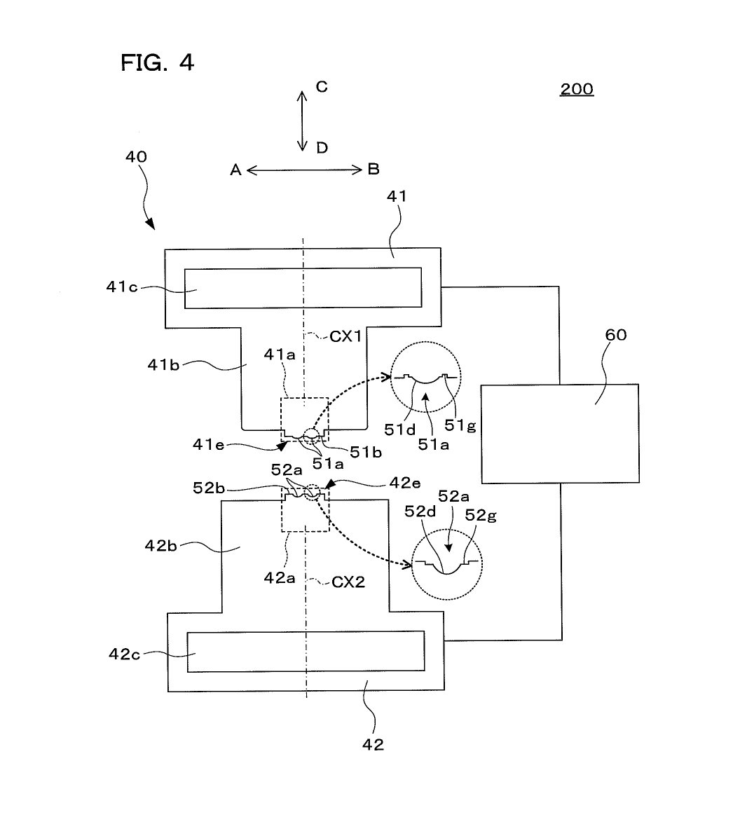

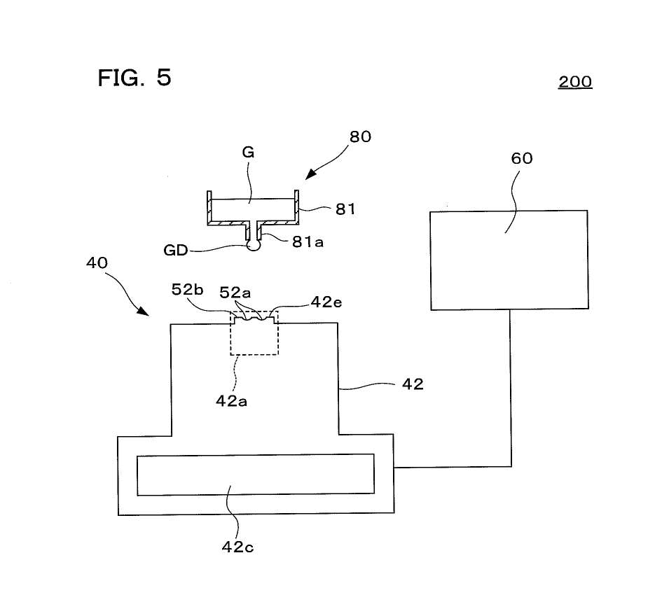

Hereinbelow, a description will be given of an example of the production method for the first and second lens arrays 101 and 102 shown in FIG. 3. A molding apparatus 200 shown in FIGS. 4 and 5 is an apparatus for pressure molding in which glass as a raw material is melted and directly pressed, and is capable of producing the lens arrays 101 and 102 of FIG. 3 as the material or component for obtaining the lens array stack 100 shown in FIG. 2(A) and others. Note that, in addition to a mold 40 as the main component, the molding apparatus 200 further includes a control drive device 60 for causing the mold 40 to move and perform opening and closing operations or the like during the production of the lens arrays 101 and 102, and a glass drop forming device 80 (see FIG. 5).

As shown in FIG. 4, the mold 40 includes a movable upper die 41 and a fixed lower die 42. During the molding, the lower die 42 is maintained in a fixed state, the upper die 41 is moved to oppose the lower die 42, and die closing is performed such that the dies 41 and 42 are caused to face each other.

The upper die 41 includes a die main body 41a, a support portion 41b, and a heater portion 41c. The lower die 42 also includes a die main body 42a, a support portion 42b, and a heater portion 42c. The die main body 41a of the upper die 41 has a plurality of element transfer surfaces 51a and a coupling surface transfer surface 51b on a die surface 41e as transfer surfaces in the molding. The die main body 42a of the lower die 42 has a plurality of element transfer surfaces 52a and a coupling surface transfer surface 52b on a die surface 42e as transfer surfaces in the molding. Herein, each element transfer surface 51a of the upper die 41 includes an optical surface transfer surface 51d and a flange surface transfer surface 51g, while each element transfer surface 52a of the lower die 42 includes an optical surface transfer surface 52d and a flange surface transfer surface 52g. When the mold 40 is to mold the lens array 101, the optical surface transfer surface 51d corresponds to the optical surface 11e of the lens main body 11a constituting the first lens element 11, while the optical surface transfer surface 52d corresponds to the optical surface 11d of the lens main body 11a. In addition, when the mold 40 is to mold the lens array 102, the optical surface transfer surface 51d corresponds to the optical surface 12e of the lens main body 12a constituting the second lens element 12, while the optical surface transfer surface 52d corresponds to the optical surface 12d of the lens main body 12a.

Note that, in the die surface 41e of the upper die 41, portions (four locations in total) of the coupling surface transfer surface 51b close to the outside of each element transfer surface 51a have a role of forming the step portions 10b and 10d, and function as the transfer surfaces for the lens elements 11 and 12 in this sense. In addition, in the die surface 42e of the lower die 42, portions (four locations in total) of the coupling surface transfer surface 52b close to the outside of each element transfer surface 52a have a role of forming the step portions 10a and 10c, and function as the transfer surfaces for the lens elements 11 and 12 in this sense. In particular, in the lower die 42, at one location of the coupling surface transfer surface 52b adjacent to the outside of the flange surface transfer surface 52g, there is formed a recessed mark transfer surface (not shown) which corresponds to the mark MA of the lens array 101. Thus, by having the concave mark transfer surface recessed from the surrounding portion, the processing of the die surface 42e is facilitated, the transfer of the mark MA is reliably performed, and the mark MA can be easily observed.

In the mold 40 shown in the drawing, the four optical surface transfer surfaces 51d provided in the upper die 41 are slightly convex, while the four optical surface transfer surfaces 52d provided in the lower die 42 are significantly concave. This is for preventing air from remaining on the element transfer surface 51a of the upper die 41 to cause a molding failure during pressure molding.

As shown in FIG. 5, the glass drop forming device 80 has a raw material supply portion 81. The raw material supply portion 81 stores molten glass G which is melted in a crucible (not shown) or the like and of which the viscosity is maintained at an appropriate viscosity, and is a portion which drips a glass drop GD obtained from the molten glass G from a nozzle 81a at a predetermined timing to thereby supply the glass drop GD to the die surface 42e of the lower die 42. The glass drop GD having landed on the die surface 42e fills in the element transfer surface 52a, spreads so as to cover the entire coupling surface transfer surface 52b, and is flattened. When a larger number of the glass drops GD have landed on the die surface 42e, there are cases where the glass drop GD flows beyond the element transfer surface 52a and further flows into the side surface of the die main body 42a. For example, when the die main body 42a is not sufficiently larger than the lens array 101 or 102 in terms of a projected area, the glass drop reaches the side surface of the die main body 42a. In this case, there is a possibility that the lens arrays 101 and 102 as molded articles cannot be removed from the die main body 42a, and hence the end surface of the die main body 42a is formed to be larger than the lens array 101 or 102 to some extent in terms of the projected area. Note that, although the glass drop GD on the die surface 42e is gradually cooled without any processing, the lens arrays 101 and 102 are molded by pressure molding using the mold 40 while the cooling rate of the glass drop GD is controlled by heating or the like by the heater portion 42c.

Returning to FIG. 4, during the pressure molding, the upper die 41 and the lower die 42 maintain a proper positional relationship therebetween such that the individual element transfer surfaces 51a of the upper die 41 and the corresponding element transfer surfaces 52a of the lower die 42 are coaxially disposed and are spaced apart at a predetermined interval at the time of pressing and at the time of cooling.

The control drive device 60 performs the control of the entire molding apparatus 200 in which the mold 40 is incorporated such as the control of electric power supply to the heater portions 41c and 42c and the opening and closing operations of the upper die 41 and the lower die 42 in order to mold the lens arrays 101 and 102 by means of the mold 40. Note that the upper die 41 driven by the control drive device 60 is capable of moving in a horizontal AB direction and also moving in a vertical CD direction, as shown in FIG. 4. For example, when the die closing of the upper and lower dies 41 and 42 is performed, first, axes CX1 and CX2 of the upper and lower dies 41 and 42 are matched with each other by moving the upper die 41 to a position above the lower die 42, the element transfer surfaces 51a on the upper side and the element transfer surfaces 52a on the lower side are thereby matched with each other, and the upper die 41 is lowered and pressed against the lower die 42 with a predetermined force.

By the above molding apparatus 200, the first and second lens arrays 101 and 102 shown in FIG. 3 can be directly formed as an integral molded article.

According to the compound lens 10 as the glass lens of the first embodiment, since the compound lens 10 has the step portions 10a and 10c each having the reduced thickness on the corners of the quadrangular contour, even when the corner portion is chipped or cracked during the transport of the compound lens 10 or the like, the enlargement of the crack can be prevented in the step portions 10a and 10c, and hence it is possible to suppress the occurrence of serious damage such as a crack which reaches the vicinity of the optical surfaces 11d and 12d.

### Second Embodiment

In the following, a description will be given of a glass lens (a lens array stack or a compound lens) according to a second embodiment. Note that the glass lens of the second embodiment is obtained by modifying the glass lens of the first embodiment, and parts which are not particularly explained are the same as those of the first embodiment.

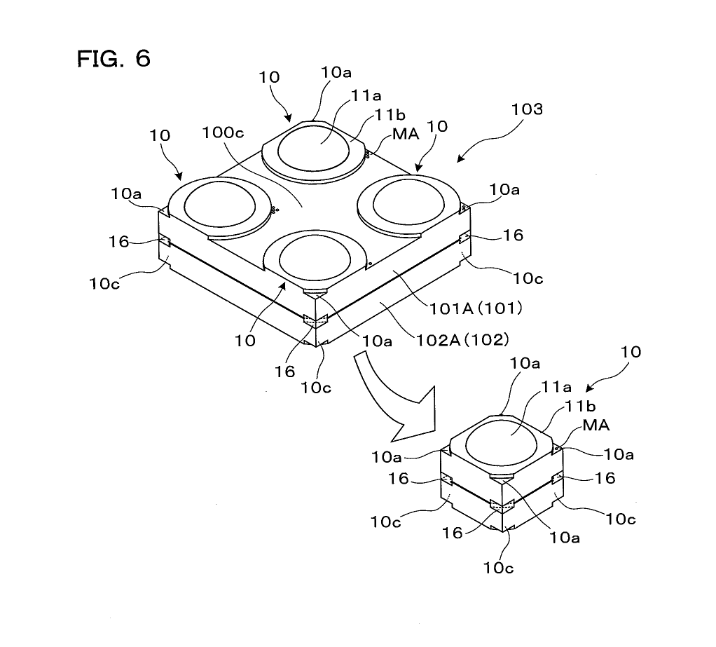

A lens array stack 103 shown in FIG. 6 is obtained by removing the surrounding portion of the lens array stack 100 shown in FIG. 2(A) and others along the boundary lines L1 and L2 from the lens array stack 100. Although the lens array stack 103 has the cross-shaped coupling portion 100c left on its central side, the lens array stack 103 is a member in the shape of the quadrangular prism as a whole, and has a quadrangular contour when viewed from the direction of the optical axis OA. The lens array stack 103 has the step portions 10a and 10c in eight top portions of the outline. Consequently, it is possible to prevent the occurrence of serious damage to the corner portion protruding outwardly when the lens array stack 103 is transported or the like.

By performing dicing on the lens array stack 103, the coupling portion 100c is removed and the lens array stack 103 is divided into the four compound lenses 10.

Note that, although first and second lens arrays 101A and 102A constituting the lens array stack 103 are formed into a quadrangular plate-like shape by stacking the first and second lens arrays 101 and 102 on each other and then cutting the surrounding portion thereof, the method of forming the first and second lens arrays 101A and 102A into the quadrangular plate-like shape is not limited thereto, and the first and second lens arrays 101A and 102A can be formed into the quadrangular plate-like shape by cutting the surrounding portions of the first and second lens arrays 101 and 102 before stacking them on each other.

### Third Embodiment

In the following, a description will be given of a glass lens (a lens array or a lens element) according to a third embodiment. Note that the glass lens of the third embodiment is obtained by modifying the glass lens of the first embodiment, and parts which are not particularly explained are the same as those of the first embodiment.

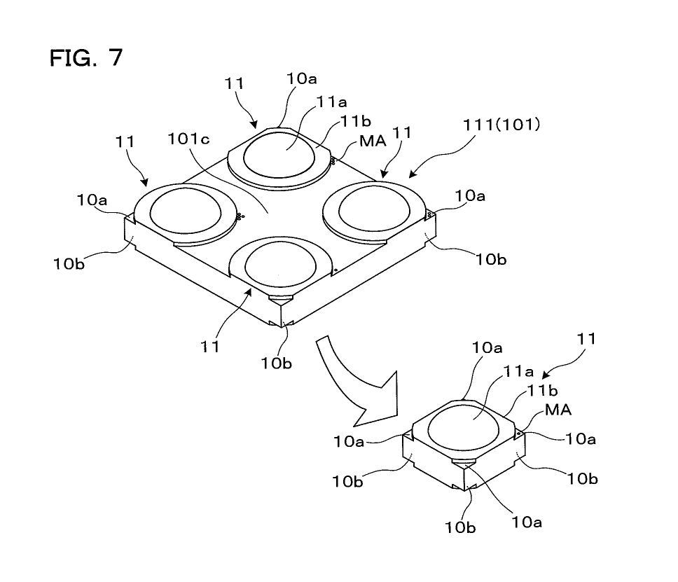

A lens array 111 shown in FIG. 7 is a glass lens obtained by removing the surrounding portion of the first lens array 101 shown in FIG. 3 from the first lens array 101. Although the lens array 111 has the cross-shaped coupling portion 101c left on its central side, the lens array 111 is a member in the shape of the quadrangular prism as a whole, and has a quadrangular contour when viewed from the direction of the optical axis OA. The lens array 111 has the step portions 10a and 10b on the front side and the back side on the four corners thereof. Consequently, it is possible to prevent the occurrence of serious damage to the corner portion protruding outwardly when the lens array 111 is transported or the like.

By performing dicing on the lens array 111, the coupling portion 101c is removed and the lens array 111 is divided into the four first lens elements 11. The first lens element 11 is a glass lens in the shape of the quadrangular prism, and has a quadrangular contour when viewed from the direction of the optical axis OA. The first lens element 11 has the step portions 10a and 10b on the front side and the back side on the four corners thereof. Consequently, it is possible to prevent the occurrence of serious damage to the corner portion of the flange portion 11b which protrudes outwardly when the first lens element 11 is transported or the like.

Although a detailed description will be omitted, in the present embodiment, the second lens element 12 shown in FIG. 1(A) and others is produced by the same method as that used for the above first lens element 11. The first lens element 11 and the second lens element 12 which are separately cut out are aligned with each other and stacked on each other with the diaphragms 15 interposed therebetween, adhered to each other by filling the space between the step portions 10b and 10d at four surrounding locations formed at this time with a resin, and the integral compound lens 10 is thereby obtained.

### Fourth Embodiment

In the following, a description will be given of a glass lens according to a fourth embodiment. Note that the glass lens of the fourth embodiment is obtained by modifying the glass lens of the first embodiment, and parts which are not particularly explained are the same as those of the first embodiment.

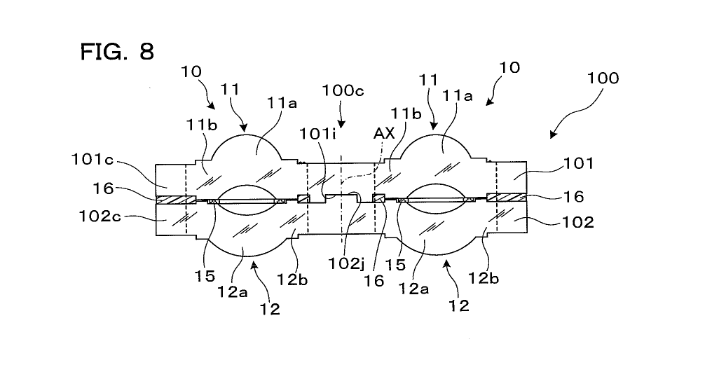

FIG. 8 shows the configuration or structure of each of the first and second lens arrays 101 and 102 constituting the lens array stack 100. The lens arrays 101 and 102 are positioned by alignment members 101i and 102j and are bonded to each other. In the example shown in the drawing, the alignment member 101i is a concave member in the shape of the quadrangular prism, while the alignment member 102j is a convex member in the shape of the quadrangular prism. By precisely molding the side surfaces of the alignment members 101i and 102j, the alignment members 101i and 102j can be fitted to each other so as to be in intimate contact with each other, and it is possible to achieve easy alignment of the lens arrays 101 and 102 when the first and second lens arrays 101 and 102 are stacked on each other. Note that an area where the alignment members 101i and 102j are provided is not limited to the portion of the coupling portion 100c present on the axis AX shown in the drawing, and the alignment members 101i and 102j can be provided in the portion of the coupling portion 100c present in the surrounding portion or at a plurality of locations in the coupling portion 100c.

### Fifth Embodiment

In the following, a description will be given of a glass lens according to a fifth embodiment. Note that the glass lens of the fifth embodiment is obtained by modifying the glass lens of the first embodiment, and parts which are not particularly explained are the same as those of the first embodiment.

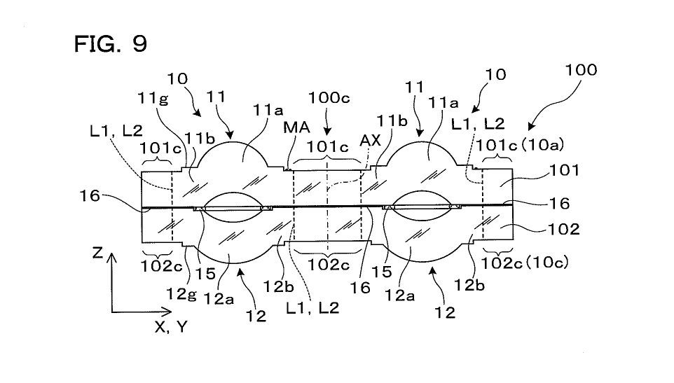

FIG. 9 shows the configuration of each of the first and second lens arrays 101 and 102 constituting the lens array stack 100. In the example shown in the drawing, the lens array 101 is formed with the step portions 10a in the coupling portions 101c, while the lens array 102 is formed with the step portions 10c in the coupling portions 102c. When compared with FIG. 1 of the first embodiment, this configuration does not have the step portions 10b and 10d at positions sandwiched between the first and second lens arrays 101 and 102. With this configuration, as compared with the first embodiment, there are cases where the redundant portion of the adhesive 16 flows to the side surfaces of the lens array 101 and 102 due to the absence of the recess RE. However, by controlling the amount of the adhesive, it is not necessary to prepare the redundant adhesive, and the adhesion strength is maintained. As in the fifth embodiment, in a case where the step portions do not interfere with each other when the lens arrays 101 and 102 are combined, the step portion can have a convex shape instead of the concave shape of 10a or 10b shown in the drawing. In this case as well, the enlargement of the crack is prevented by the flange surfaces 11g and 12g of the lens arrays 101 and 102 and the convex step portions formed in the corner portions, and hence serious damage extending from the corner portion protruding outwardly toward the optical surfaces 11d and 12d or the like is unlikely to occur.

Thus, the production methods or the like for the optical element according to the present embodiments have been described, the production method or the like for the optical element according to the present invention is not limited thereto. For example, in the above embodiments, the shape and size of each of the optical surfaces 11d, 11e, 12d, and 12e can be appropriately changed in accordance with usage and functions.

In addition, the configuration of the compound lens 10 is not limited to the configuration in which the compound lens 10 is constituted only by the first and second lens elements 11 and 12, and the compound lens 10 can be constituted by three or more lens elements. In this case as well, the step portions may be appropriately provided in, e.g., eight top portions of the outline.

The shape of the compound lens 10 does not need to be the shape of a square prism, and can be the shape of a rectangular prism. In this case as well, the step portions may be appropriately provided in, e.g., eight top portions of the outline.

The shape of each of the first and second lens arrays 101 and 102 does not need to be the disc-like shape, and each of the first and second lens arrays 101 and 102 can have various contours such as an oblong contour or the like. For example, by forming each of the first and second lens arrays 101 and 102 into the quadrangular plate-like shape as shown in FIGS. 6 and 7 from the beginning, it is possible to omit the step of dicing. In addition, the number of first or second lens elements 11 or 12 formed in the first or second lens array 101 and 102 is not limited to four, and the number thereof can be two or more. In this case, the first and second lens elements 11 and 12 are desirably disposed at the lattice points for the convenience of dicing. Further, the spacing between the adjacent lens elements 11 and 12 is not limited to the spacing shown in the drawings, and the spacing therebetween can be appropriately set in consideration of processability or the like.

The number of locations of the step formed in the top portion of the outline of each of the compound lens 10, the lens array stack 103, and the lens arrays 101 and 102 or the like is not limited to eight locations, and can be limited to, e.g., four locations which tend to be brought into contact with other members.

In the above embodiments, by further adjusting the step amounts in the step portions 10a, 10b, 10c, and 10d, it is possible to adjust the thickness of the layer of the adhesive 16.

The mark MA formed in each of the lens elements 11 and 12 is not limited to the one shown in the drawings, and various marks can be used. Further, the information retained in the mark MA is not limited to the information on the position in each of the lens arrays 101 and 102, and the mark MA can retain various information items including properties of the lens, the history thereof, or the like. The mark MA can be formed not only on one side but also on both sides of each of the lens elements 11 and 12, and can also be formed on all of the steps on the four corners.

In the above embodiments, although the lens arrays 101 and 102 are molded by pressing molten glass, the lens arrays 101 and 102 can also be molded by softening a glass gob and processing and transferring the softened glass gob (reheat press).

1. A glass lens comprising:
a lens main body; and
a flange portion extending around the lens main body, wherein
the glass lens has a quadrangular contour when viewed from an optical axis direction of the lens main body, and a step portion having a reduced thickness on a corner of the quadrangular contour.

2. The glass lens according to claim 1, wherein the flange portion has step portions on four corners of a quadrangular outline.

3. The glass lens according to claim 2, wherein the flange portion has the step portions on a front side and a back side respectively when viewed from the optical axis direction on the four corners of the quadrangular outline.

4. The glass lens according to claim 2 further comprising:
a protruding mark on a surface of the step portion provided on at least one of the four corners of the quadrangular outline.

5. The glass lens according to claim 1, which is formed by stacking a plurality of lens elements each having a set of the lens main body and the flange portion on each other, and has the step portions in eight top portions of an outline having a shape of a quadrangular prism as a whole as a result of the stacking.

6. The glass lens according to claim 5, wherein the plurality of lens elements are stacked on each other in a state in which the flange portions are in contact with each other, and are bonded to each other by filling a space between opposing flange surfaces or the opposing step portions with an adhesive.

7. The glass lens according to claim 6, further comprising a diaphragm which is sandwiched between the plurality of lens elements and fixed.

8. The glass lens according to claim 1, which has a lens array in which a plurality of lens elements each having a set of the lens main body and the flange portion are two-dimensionally disposed and integrated, and the step portions on four corners of a quadrangular plate-like outline of the lens array.

9. The glass lens according to claim 8, which is formed by stacking a plurality of the lens arrays on each other, and has the step portions in eight top portions of an outline having a shape of a quadrangular prism as a whole as a result of the stacking.
